(19) United States
(12) Patent Application Publication
(10) Pub. No.: US 2011/0089348 A1
(43) Pub. Date: Apr. 21, 2011

(54) METHOD AND APPARATUS FOR THIN FILM QUALITY CONTROL

(76) Inventors: Moshe Finarov, Rehovot (IL); David Scheiner, Savyon (IL); Yoav Lishzinker, Tel Aviv (IL); On Haran, Kefar Sava (IL)

(21) Appl. No.: 12/966,595

(22) Filed: Dec. 13, 2010

Related U.S. Application Data
(63) Continuation-in-part of application No. 12/775,293, filed on May 6, 2010.
Application No. 12/775,293 is a continuation-in-part of application No. 12/410,878, filed on Mar. 25, 2009.
(60) Provisional application No. 61/287,327, filed on Dec. 17, 2009.
(60) Provisional application No. 61/080,279, filed on Jul. 14, 2008.
(60) Provisional application No. 61/105,931, filed on Oct. 16, 2008.
(60) Provisional application No. 61/160,294, filed on Mar. 14, 2009.
(60) Provisional application No. 61/160,374, filed on Mar. 16, 2009.
(60) Provisional application No. 61/226,735, filed on Jul. 19, 2009.

(51) Int. Cl. G01N 21/86

(52) U.S. Cl. 250/559.39

(57) ABSTRACT

Photovoltaic thin film quality control is obtained where the thin film is supported by a support and a section of the film is illuminated by a polychromatic or monochromatic illumination source. The illumination is positioned in certain locations including locations where the layer stack includes a reduced number of thin film layers. Such locations may be discrete sampled points located within scribe lines, contact frames or dedicated measurement targets. The light collected from such discrete sampled points is transferred to a photo-sensitive sensor through an optical switch. The spectral signal of the light reflected, transmitted or scattered by the sampled points is collected by the sensor and processed by a controller in such a way that parameters of simplified stacks are used for accurate determination of desired parameters of the full cell stack. In this way the photovoltaic thin film parameters applicable to the quality control are derived e.g. thin film thickness, index of refraction, extinction coefficient, absorption coefficient, energy gap, conductivity, crystallinity, surface roughness, crystal phase, material composition and photoluminescence spectrum and intensity. Manufacturing equipment parameters influencing the material properties may be changed to provide a uniform thin film layer with pre-defined properties.

### CROSS-REFERENCE TO RELATED APPLICATIONS

This is a United States non-provisional application being filed under 35 USC 111 and 37 CFR 1.53(b) and it claims benefit of United States Provisional Application for patent assigned Ser. No. 61/287,327 and filed on Dec. 17, 2009. The present application is a continuation-in-part of U.S. patent application Ser. No. 12/775,293 filed on May 6, 2010, which is a continuation-in-part of U.S. patent application Ser. No. 12/410,878 filed on Mar. 25, 2009, which application claims the benefit of the priority of United States Provisional Application for patent assigned Ser. No. 61/080,279 and filed on Jul. 14, 2008, as well as United States Provisional Application for patent assigned Ser. No. 61/105,931 filed on Oct. 16, 2008, each of these three applications being incorporated herein by reference in their entirety. The application also incorporates by reference United States Provisional Application for patent assigned Ser. No. 61/160,294 and filed on Mar. 14, 2009, United States Provisional Application for patent assigned Ser. No. 61/160,374 and filed on Mar. 16, 2009, and United States Provisional Application for patent assigned Ser. No. 61/226,735 and filed on Jul. 19, 2009 all of which have been commonly assigned to the same assignee.

### TECHNOLOGY FIELD

The method and system relate to the area of thin film quality control and in particular, to the quality and process control in manufacturing thin film photovoltaic cells.

### BACKGROUND

Scarcity and environmental effects of fossil energy sources that emerged in recent years have accelerated development of alternative energy sources. Thin film photovoltaic solar panels, being one such source, have attracted particular attention. These panels represent a number of different thin films (stack) deposited on large size flexible web substrates or large size rigid substrates like glass, metal and others. The films may be of such materials as dielectrics, metals, semiconductors, and are typically combined in multilayer stacks usually separated by so-called scribe lines into a plurality of individual photovoltaic cells. In addition to separating the cells, the scribe lines enable serial connection of individual photovoltaic cells increasing the voltage generated by the panel.

The panels are produced in a continuous production process, where they are transferred from one station to another by conveyor type facilities. The continuous production process does not allow the process to be stopped, and panel quality control off-line to be performed as in other thin film industries. Accordingly, the layer quality control should either be a part of the production process or what is known as on-line quality control. The speed of the on-line quality control should be such as to allow the production process to be maintained without reducing the conveyor speed and, at the same time allow, material characterization, defect detection, defect classification and generation of feedback to the forward or backward located production stations with respect to the quality control system production systems and, if possible, defect repair.

There are several important material parameters of the thin films which need to be known to successfully control the process. These parameters include: the refractive index (n) and the extinction coefficient (k), both as a function of the wavelength, the film thickness (d), roughness, energy gap, absorption, roughness, conductivity, crystallinity percentage, crystal phase or material composition, photoluminescence spectrum and intensity as well as some other parameters. To provide information useful for quality assessment, these parameters should be measured continuously and almost simultaneously across the width of the moving panel/web such that the measurement data collected will provide a sufficient data density required for mapping real time monitoring of a respective process quality. The measurement process and measurement conditions should be the same for each of sampled points and the signal-to-noise ratio of the measurement should enable determination of reliable thin film optical parameters.

Availability of such a method of thin film quality control would significantly improve the quality of thin film solar panel production, improve the yield, and reduce the costs. The photovoltaic solar thin film production industry would welcome such a method and would use it for different thin film production applications.

### BRIEF SUMMARY

A method and apparatus for a photovoltaic thin film quality control where the thin film is supported by a support and a section of the film is illuminated by a polychromatic illumination source or a monochromatic illumination source such as laser. The source may form on the thin film a substantially continuous illuminated line or illuminate discrete sampling points. A sampling unit samples a plurality of discrete sampled points located on the illuminated line and images these points onto an optical switch. The sampled points maybe located within individual photovoltaic cells (PV), inside scribe lines (SL) or other intentionally introduced locations or sampling targets. A control unit with the help of a calibration scanner generates a concordance look-up-table between the coordinates of the above sampled points on the thin film and their coordinates on the optical switch. A single detector samples all of the points by optically switching between the points and determines the spectral signal of the illumination reflected, transmitted or scattered by the sampled points. The photovoltaic thin film parameters applicable to the quality control are derived from the spectral signal and include film thickness, index of refraction, extinction or absorption coefficients, surface roughness, crystallinity percentage, conductivity, energy gap, crystal phase, material composition and others. The derived film parameters are applied to adjust manufacturing equipment process control parameters.

### BRIEF DESCRIPTION OF THE DRAWINGS

The method and system disclosed are herein presented, by way of non-limiting examples only, with reference to the accompanying drawings, wherein like numerals depict the same elements throughout the text of the specifications. The drawings are not necessarily to scale, emphasis instead being placed upon illustrating the principles of the method.

FIGS. 1A-1C are schematic illustrations of some exemplary embodiments of the present system for thin film parameters quality control.

FIGS. 2A and 2B are schematic illustrations of exemplary embodiments of the illumination units of the present system for thin film parameters quality control.

FIGS. 3A and 3B are exemplary embodiments of the illumination units butting configuration.

FIGS. 4A-4E are schematic illustrations of some exemplary embodiments of the optical sampling unit of the present system for thin film parameters quality control.

FIGS. 5A-5D are schematic illustrations of some exemplary embodiments of the coordinate calibration facility of the sampling unit.

FIG. 6 is a schematic illustration of an exemplary embodiment of the spectral calibration facility of the sampling unit.

FIG. 7 is a schematic illustration of the process of matching the actually measured spectrum data of illumination reflected (or transmitted) from a thin film to a theoretical thin film spectrum.

FIGS. 8A and 8B are schematic illustrations of an exemplary embodiment of a thin film quality control process employing the present system.

FIG. 9 is a schematic illustration of another exemplary embodiment of a thin film quality control process employing the present system.

FIG. 10 is a flow diagram illustrating the steps involved in an exemplary system.

FIG. 11 is a schematic illustration of a photovoltaic panel including scribe lines at one of the stages of an exemplary panel production process.

FIG. 12 is a schematic illustration of a photovoltaic panel including scribe lines after another stage of an exemplary panel production process.

FIG. 13 is a schematic illustration of an exemplary photovoltaic panel quality control apparatus.

FIG. 14 is a schematic illustration of operation of measurement units controlling different segments of a photovoltaic panel with different sampling frequency or resolution.

FIG. 15 is a schematic illustration of a measurement unit following the orientation of scribe lines of the controlled photovoltaic panel.

FIG. 16 is a flow chart illustrating the process of photovoltaic panel quality control process according to the present method.

FIG. 17 is a schematic illustration of an additional exemplary photovoltaic panel quality control apparatus.

### GLOSSARY

The term “thin film” as used in the current disclosure means a single photovoltaic thin film and a plurality of thin films with each film deposited on the top of the previous one or what is known as a “stack.”

Any one of the terms, “reflection” or “transmission” as used in the present disclosure incorporate both reflection and transmission phenomena.

Any one of the terms, “light”, “illumination” or “radiation” as used in the present disclosure has the same meaning.

The term “sampled point” as used in the current disclosure means any point of the thin film at which reflection or transmission spectra or scattering is measured.

The term “collected” means light reflected, transmitted or scattered by a sampled point and received by a sensor.

The term “individual photovoltaic cell” as used in the current disclosure means any thin film photovoltaic cell bound by scribe lines scribed in different thin films of the stack.

The term “panel” as used in the current disclosure means a plurality of photovoltaic cells located on the same substrate and electrically connected between them.

The term “Raman scattering” relates to inelastic scattering where the scattered light has a different wavelength than that of the incident light wavelength.

The term “reduced number of thin film layers” as used in the current disclosure means non-complete thin film photovoltaic panel stack including at least one thin film layer.

### DETAILED DESCRIPTION OF EXEMPLARY EMBODIMENTS

In the following detailed description, for purposes of explanation only, numerous specific details are set forth in order to provide a thorough understanding of the present system and method. It will be apparent, however, that the present system and method may be practiced without these specific details. In other instances, well-known structures and devices are schematically shown in order to simplify the drawings.

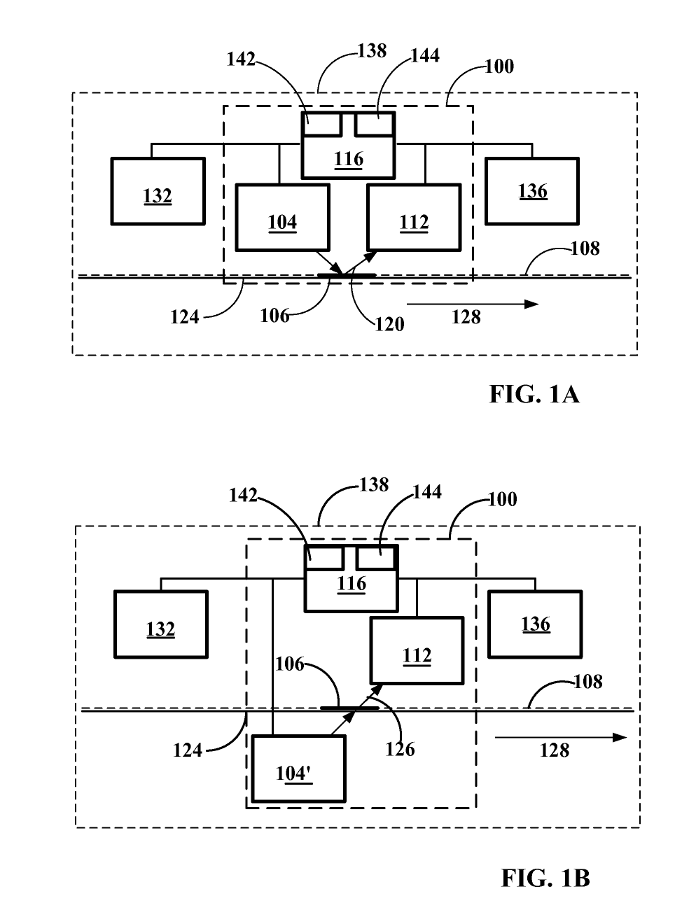

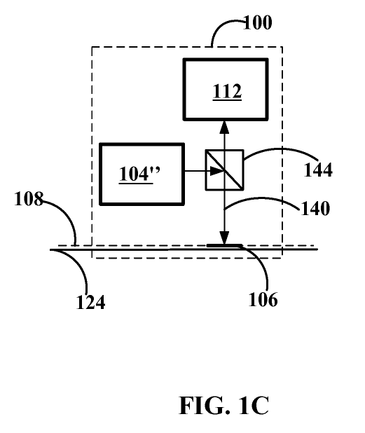

Reference is made to FIG. 1A, which is a schematic illustration of an exemplary embodiment of the present system for thin film parameters quality control. System 100 includes one or more illumination units 104 configured and operative to illuminate an object plane 106, which coincides with a section of the controlled thin film 108; an optical sampling unit 112 configured and operative to sample multiple discrete points located in the object plane 106 and coinciding with illuminated segment of film 108, and a control unit 116 configured and operative to control the operation of illumination 104 and sampling 112 units, and process the sampled data, which determines thin film 108 thickness and optionally other parameters. FIG. 1A illustrates system 100 including illumination unit 104 and sampling unit 112, which are configured to operate with light beam 120 reflected from the thin film 108 illustrated as being located in object plane 106. FIG. 1B illustrates system 100 including illumination unit 104′, and sampling unit 112 of which are configured to operate with light beam 126 which is transmitted through the thin film 108. Illumination units 104 and 104′ may provide polychromatic illumination or monochromatic illumination, such as laser illumination.

FIG. 1C illustrates system 100 including illumination unit 104″ that may be configured to provide polychromatic illumination or monochromatic illumination, such as laser illumination or light, and sampling 112 unit, which is configured to operate with light beam 140, normally incident on and reflected from object plane 106. Object plane 106 coincides with thin film 108. A beam splitter 144 of any known construction supports operation of such a system. In an alternative embodiment, system 100 including illumination 104 (104′, 104″) and sampling 112 units may be located on both sides (below and above) the thin film layer to be controlled, as disclosed in Provisional Patent Application Ser. No. 61/160,294 (Presently Patent Cooperation Treaty Application PCT/IL2010/000174 filed on Mar. 3, 2010) which is incorporated above by reference. The illumination units may illuminate the controlled thin film simultaneously from both sides and the sampling units may read the sampled points simultaneously from both sides of the thin film.

Operation of any one of the systems illustrated in FIG. 1A through FIG. 1C provides required measurement results.

Typically, one or more thin films 108 could be deposited on a rigid or flexible substrate 124 that may be sheet cut or a continuous web substrate. Thin film deposition is a continuous production process and in order to coat and pattern different substrate segments by one or more thin films 108, the substrate is translated between different production stations located backward 132 (See FIGS. 1A and 1B), with respect to system 100, or forward 136 along a pre-determined direction as shown by arrow 128. The stations may be different layers deposition stations, scribing stations, contact shunt burning stations, and others. System 100 could be configured as an in-line quality control system and utilize the existing system production line substrate translation facilities or as an off-line system having its own substrate translation facility (not shown). The existing substrate translation facilities may be a conveyor, a rigid panel support or other translation facilities suitable for translating the substrate with the deposited or coated film on it in a controllable manner. One or more stations may be equipped with a sensor for detecting the panel edge or another geometrical attribute (e.g. coordinates of a scribe line, photovoltaic cells pattern, etc.), for synchronizing panel movement and operation of optical sampling units (not shown).

Control unit 116 (FIGS. 1A and 1B) includes a memory 142 that stores different data used through the thin film quality control process, a communication module 148 controlling a number of communication links enabling communication between different units and stations of system 100, for example substrate translation facilities, film deposition stations, and/or control facility, and communications with the forward and backward located thin film production systems. The communication links may be standard wire or wireless communication networks communicating by standard protocols or via a recordable media. These communication links enable effective thin film production process control.

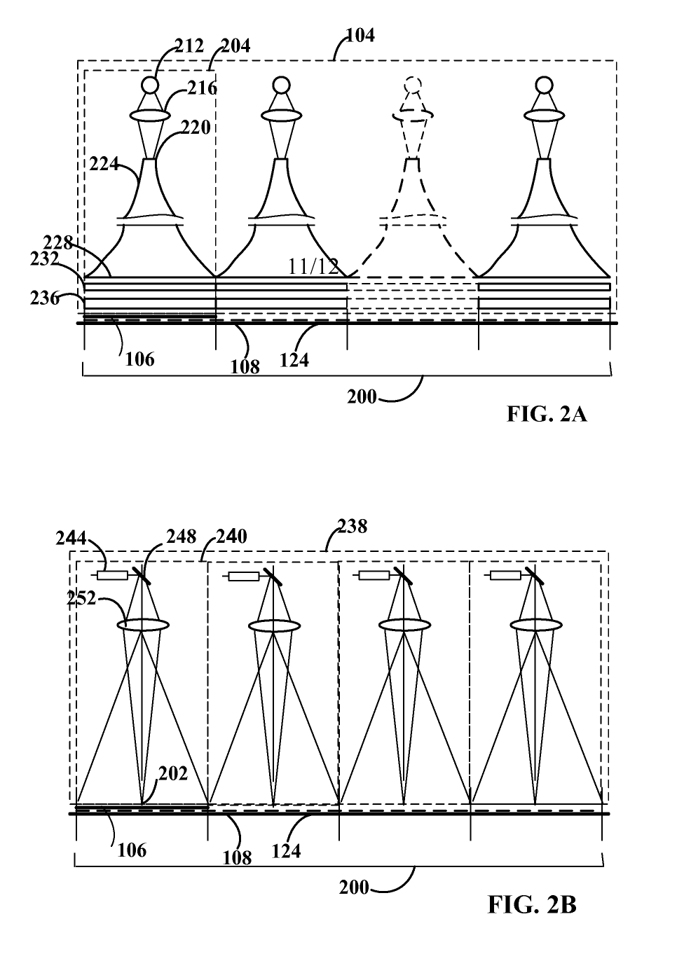

FIG. 2A is a schematic illustration of an exemplary embodiment of the illumination unit of the present system for quality control of the thin film parameters. Substrates, on which are deposited one or more different thin films (stack), could be from a few centimeters wide to a few meters wide. Illumination unit 104 illuminates a segment 200 of thin film 108, or another object to be controlled, either located or coinciding with object plane 106 of system 100. The illuminated segment has a length equal or greater than the full film 108 width.

Each of the illuminations sub-units 204 include a light source 212 such as an incandescent lamp or arc lamp, luminescence lamp, white LED or an assembly of LEDs forming a polychromatic light source. The spectrum of polychromatic illumination sources 212 is selected such as to ensure that at least a part of the thin film controlled is partially transparent. A condenser lens 216 collects the illumination emitted by source 212 and images source 212 on the first end or input facet 220 of a fiber optics bundle 224. Lens 216 also matches the illuminating beam aperture to the aperture of fiber optics bundle 224. First end 220 of fiber optics bundle 224 is planar and configured into a round or rectangular shape with dimensions of 15 mm to 25 mm. The second end or output facet 228 of fiber optics bundle 224 is configured into a line. Assuming a bundle of 200,000 fifty-micron diameter fibers, the line would be about 1000 mm long. In some embodiments fibers may be located such that there will be a distance between them illuminating discrete locations and forming a line e.g. longer than 1000 mm. In order to provide a more homogeneous illumination distribution along the illuminated line, a diffuser 232 is inserted between second end 228 of bundle 224 and cylindrical lens 236 imaging the second end 228 in the object plane 106 coinciding with thin film 108 plane.

FIG. 2B is a schematic illustration of another exemplary embodiment of the illumination unit of the present system for quality control of the thin film parameters. Illumination unit 238 that includes a number of sub-units 240, illuminating discrete points along a segment 200 of thin film 108, or another object to be controlled, either located or coinciding with object plane 106 of sub-unit 240. The illuminated segment 200 has a length equal or greater than the full film 108 width.

Illumination unit 238 is a laser based illumination unit. A laser light source is selected to ensure efficient inelastic Raman scattering useful for measuring structural properties of film 108. Each of the illuminations sub-units 240 includes a light source 244 such as a green 514 nm Argon laser or a red HeNe laser emitting at 632.8 nm, or semiconductor green lasers emitting in the range of 500 nm to 515 nm commercially available from Nichia Co. Ltd., Tokushima Japan, or Sumitomo Co. Ltd., Tokyo Japan and Osram GmbH, Munich Germany and semiconductor red lasers emitting in the range of 615 nm to 652 nm available from Sony Tokyo Japan and Sanyo Tokyo Japan and a number of other manufacturers as well as an optional scanning mirror 248 and a lens 252. Lens 252 forms on the controlled thin film a spot 202 of several tens to several hundreds of microns. The spot size, illumination time, and the power density that the spot couples to the thin film are selected to enable reliable thin film parameters measurement and efficient Raman scattering without causing crystallization or other negative effects within the measured thin film. The lasers may be operated in a continuous operation mode or pulse mode with pulse duration of several milliseconds to a few seconds. Operation in pulse mode may be synchronized with measurement locations during panel movement on a conveyer. It should be noted that light delivery to the sampling points, e.g. from a laser, can be also provided via an optical switch.

In some embodiments the illumination unit may include both polychromatic light sources and monochromatic light sources such as lasers. Different optical elements such as beam combiners and similar (not shown) may be used to enable illumination of the same controlled thin film sampled spot by each of the illumination types.

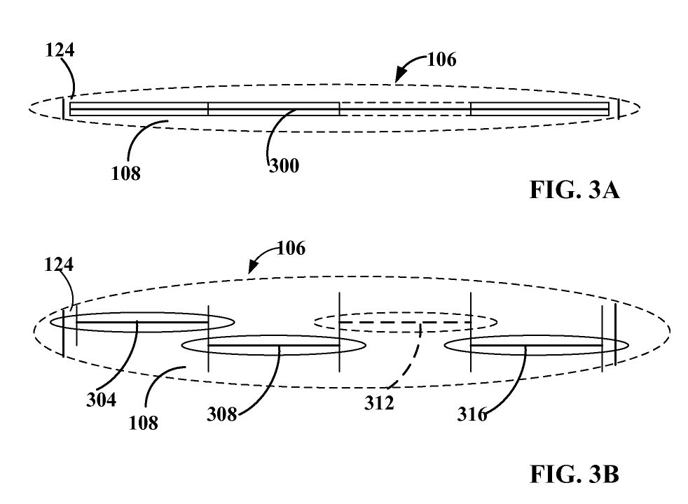

A number of illumination sub-units 204 with each sub-unit illuminating a segment 300 (FIG. 3A) of object plane 106 containing thin film 108 are arranged such that the full illuminated forms a substantially continuous line. The dimensions of the line being equal or greater than substrate 124 width. FIGS. 3A and 3B are exemplary embodiments of the object plane 106 illuminated by illumination sources 204 operative to illuminate a line spanning across the full substrate width. Depending on this width, it may include a number of illumination units or sources 204 seamlessly butted, as shown in FIG. 3A, to illuminate substantially a line 300 on film 108. Alternatively, illumination sources 204 or 240 may be staggered and illuminate different segments 304, 308, 312, and 316 of object plane 106 and film 108 (FIG. 3B). Lasers may be set to provide an illumination at discrete locations over the desired sampling points in a linear or staggered array. Multiple discrete locations may be illuminated either by multiple lasers or by one laser e.g. by means of fiber bundle. Synchronization of the sampled points located in these sections may be done electronically.

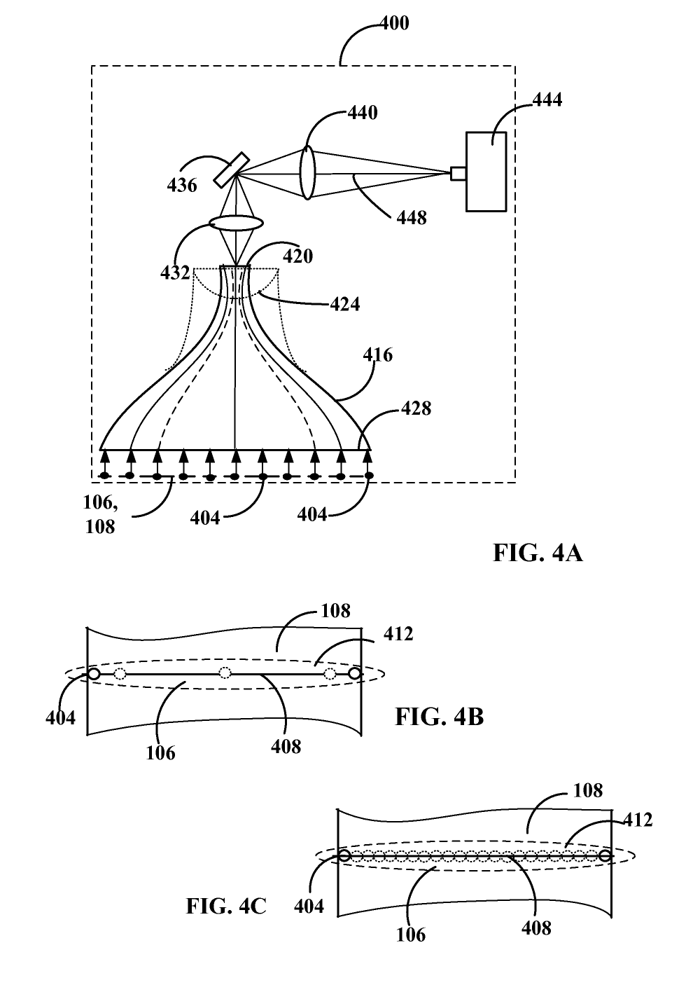

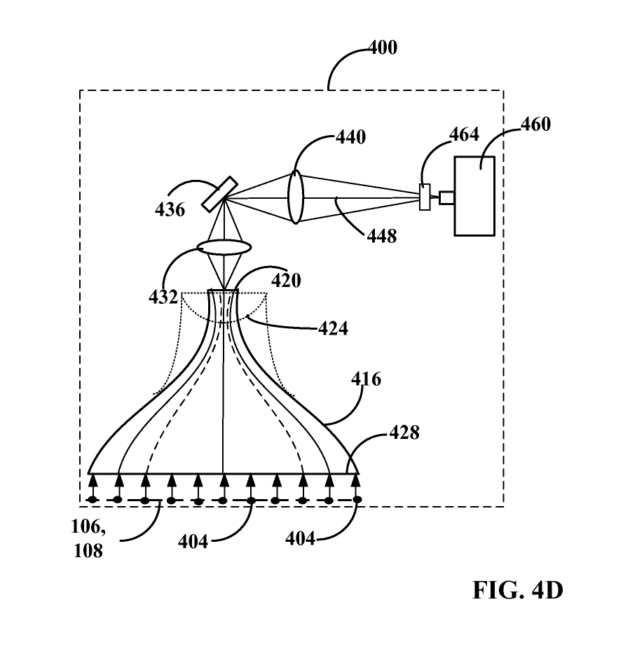

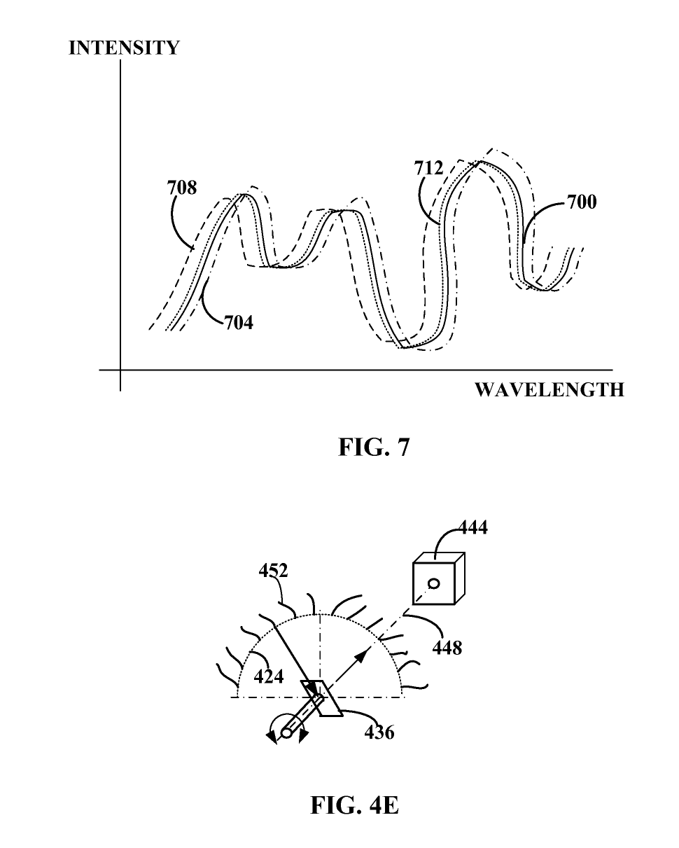

FIG. 4A is a schematic illustration of an exemplary embodiment of the optical sampling unit of the present system for the thin film parameters quality control. Sampling unit 400 samples a plurality of discrete sampled points 404 residing on the same line 408 (FIG. 4B) in the illuminated object plane 106 coinciding with segment 412 of the controlled thin film 108. Unit 400 includes an optical shape converter 416 configured to convert illuminated line 408 into a two-dimensional plane 420 or into a curved space or line 424. A fiber optics bundle with about 20,000 fibers is picking-up or receiving sampled points spaced about 1 mm or less from each other would be sufficient for such a converter. The input facet or first end 428 of bundle 416 is arranged into a one-dimensional shape, e.g. straight line. The output facet or second end 420 of bundle 416, depending on the type of optical switch, may be a plane, typically of a rectangular or circular shape, or a curved line 424 for example, such as a segment of a circle. Bundle 416 conveys the illumination or radiation reflected from or transmitted through thin film 108 onto output facet 420 or 424 of bundle 416. Output facet 420 of bundle 416 may have a diameter of about 5-25 mm. A lens 432 images or transfers output facet 420 onto a two-dimensional optical switch 436. Switch 436 may be a deflectable micro minor matrix, e.g. Digital Mirror Device (DMD) with about 1024 times 768 (micro mirrors) pixels and size of about 11 by 14 mm² commercially available from Texas Instruments, Inc., Dallas, Tex. 75243, USA, or of any other type of switch enabling very short switching time (less than 1 millisecond). Switch 436 reflects and directs in a sequential manner through lens 440 radiation received from each of the sampled points 404 to a spectrometer 444, such as MCS 1 spectrometer, commercially available from Carl Zeiss, Jena, Germany. Spectrometer 444 has a built-in photo detector able to measure simultaneously light intensity at multiple wavelengths. When the switch mirror does not direct the selected light beam to spectrometer 444, the reflected radiation is directed outside the aperture of lens 440 and thus is not measured by the spectrometer.

In an alternative embodiment, illustrated in FIG. 4C, sampled points 404 of the input facet of first end 428 of bundle 416 located on line 408 are arranged such that they enable radiation to be addressed and collected from any one of the points located on line 408. One or more DMDs synchronized between them may sample the output of the end 420 of bundle 416. Ability to address any sampled point in object plane 106 enables sampling and light collection of different object plane segments with different resolution. Some segments of object plane 106 may be sampled more densely than other sections. This enables flexibility in applying different application specific resolutions to scanning different thin films and their combinations.

FIG. 4D is a schematic illustration of an exemplary embodiment of the sampling unit of the present system for thin film parameters quality control for measuring Raman scattering from the controlled thin film. Spectrometer 444 is replaced by a spectrometer 460 operative to measure Raman spectrum of scattered light (collected or received from measured thin film 108), which may be such a spectrometer as Dimension-P1™ Raman spectrometer commercially available from Lambda Solutions, Inc., Waltham, Mass. 02452, U.S.A., or model Holospec f/1.8 commercially available from Kaiser Optical Systems, Inc., Ann Arbor Mich. 48103 U.S.A. In case of measuring Raman spectrum signal, illumination system 240 (FIG. 2) may include also a narrow-band (notch) filter for ensuring highly monochromatic illumination. A “notch” (a narrow band) or long-pass step filter 464 mounted at the entrance to the spectrometer rejects the illuminating light from the exciting laser and transmits the light scattered by the thin film 108 only.

In some embodiments of the sampling unit both Raman spectrometer 460 and spectrometer 444 may be present and optical switch 436 or an additional minor may be operative to direct the spectrum to be analyzed to the proper spectrometer. Operation of switch 436 or of the additional mirror may be synchronized with the operation of the illumination sources and spectrometers. In order to determine additional thin film parameters, Raman scattering measurements can be combined with either reflectance or transmittance measurements or both by sampling on points located in a close proximity to the Raman sampling point.

When output facet or second end of bundle 416 (FIGS. 4A and 4D) is configured in a curved line 424 such as a segment of a circle and the optical switch is a rotating minor, mirror 436 acts as a scanning mirror rotating around an axis 448 (FIG. 4E) related in space to the optical axis of spectrometer 444. Individual fibers 452 forming curved line 424, which is a segment of a circle, are located in a plane perpendicular to axis 448. In this embodiment, curved line 424 is centered on axis 448 however, other spatial placement of the mirror axis and spectrometer optical axis are possible. The size of the rotating minor 436, appropriate optical focusing elements (not shown) and the distance between the neighbor fibers forming curved line 424 may be selected such as to reduce interference with illumination transmitted by other fibers and to fully utilize the extent of the light beam emitted from the fibers. The numerical aperture of fibers forming curved line 424 may be selected to match the numerical aperture of spectrometer 444.

Thin film optical parameters such as the film thickness (d), film refractive index (n), film extinction coefficient (k), surface roughness, intensity and spectrum of photoluminescence or Raman scattering, and the like may change between the sampled points 404. These parameters characterize the quality of the thin film as well as that of the process of its manufacture and influence the reflected/transmitted light spectrum. Spectrometer 444 is operative to determine the spectral signal of the light collected from each of sampled points 404, enabling, as explained below, determination of these parameters. Specific material parameters can be extracted from the measurements of the thin film characteristics, for example by help of using dielectric function models for fitting the wavelength dispersion of the refractive index (n) and the extinction coefficient (k). The parameters can include film thickness, energy gap, absorption coefficient, surface roughness, conductivity, crystallinity percentage, crystal phase or material composition. It should be noted that the crystallinity may be determined using either absorption coefficient or by analyzing Raman scattering spectrum. [“Relationship between Raman crystallinity and open-circuit voltage in microcrystalline silicon solar cells”, C. Droz, E. Vallat-Sauvain, J. Bailat, L. Feitknecht, J. Meier, A. Shah, Solar Energy Materials and Solar Cells 81, issue 1, 61-71, 2004]. Sampling unit 400 selects and samples a plurality of points 404 located on a straight line 408 residing in the illuminated object plane 106 of thin film 108. Particular thin film production process or thin film materials may determine the number, size and location of sampled points 404, for example, the sampled points may be located within individual photovoltaic cells, scribe lines, contact frames, and specially introduced measurement targets. In order to interpret the measured spectrum into thin film parameters at the particular sampled point 404 it is desirable to have coordinates of each of the sampled points on the thin film. This may be achieved, for a coordinate axis along the panel width, by a process of calibration in course of which a concordance or look-up-table (LUT) between the location of each of the sampled point 404 on illuminated line 408 of the controlled thin film 108 and its image spot on two-dimensional switch 436 or on a curved line 424 is determined as well as for coordinate axis along the panel length by controlling the movement of the measured panel on a conveyer.

It should be noted that knowledge of the above measured material parameters and their spatial distribution within the thin film enables improvement of deposition process or treatment of the thin film and in particularly thin film uniformity. This may be done for example, by varying process equipment control parameters such as deposition time, deposition temperature, deposition rate, pressure in the deposition chamber, deposition source material composition, etc.

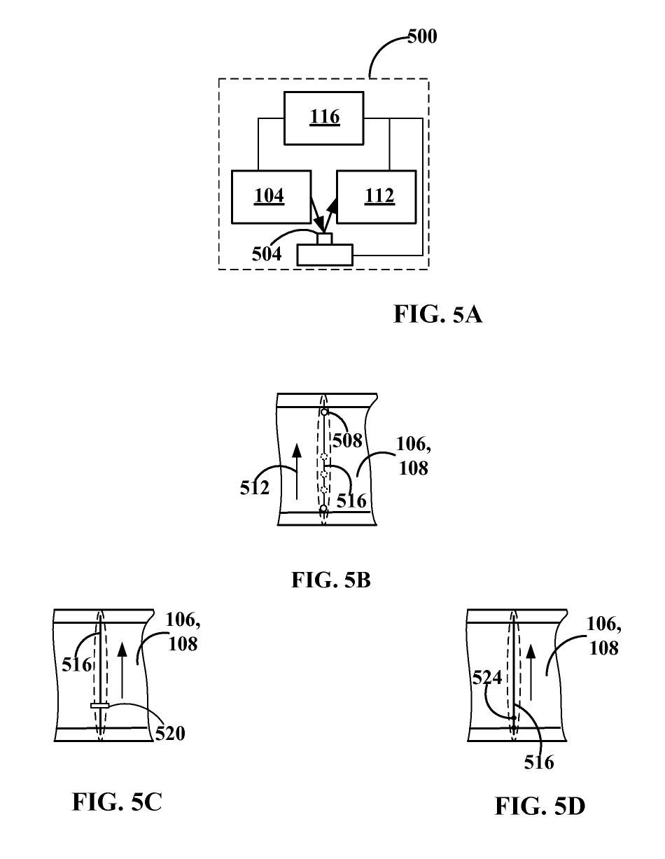

The coordinate calibration facility 500, a schematic illustration of an exemplary embodiment of which is shown in FIG. 5A, utilizes for example, the illumination unit 104, sampling unit 112, and control computer 116. Facility 500 may include a small size mirror 504 (similar in dimensions to the size of an individual optical fiber) that moves, as shown by arrow 512 (FIG. 5B), along the illuminated line/segment 516 such that at any location it reflects light from only one sampled point 508. Generally, for coordinate determination it would be sufficient to receive the light by at least one pixel (micro mirror) of switch 436 or, in case when the switch is a scanning mirror, the light picked-up by a single fiber of bundle 416 (FIG. 4).

In a case when one fiber illuminates several mirrors on the optical switch, all these mirrors should be identified and attributed to the selected sampled point. The detector of spectrometer 444 or 460 measures the radiation or light intensity reflected by each of these mirrors and determines the one with the maximal intensity. Coordinates of each of the pixels of switch 436 are well known, and coordinates of the mirror 504 moving along illuminated line could be easily identified by connecting a linear or rotary encoder to the minor. Based on these coordinates a concordance or LUT containing corresponding coordinates of the sampled points on the controlled thin film corresponding to their coordinates on the converter facets can be prepared. It should be noted that in case of transmission configuration as shown in FIGS. 5C and 5D instead of small mirror 504 a small slit 520 or diaphragm 524 may be used.

The diameter of individual fibers forming bundle 416 is about 50 micron. The size of an individual micro mirror (pixel) of switch 436 is about 14×14 micron or less. Under the assumption that lens 432 images bundle 416 (FIG. 4) output facet with magnification 1:1, ten to fourteen micro mirrors (pixels) would receive reflected or transmitted illumination conducted by a single fiber. The accuracy of coordinate determination may be increased by proper processing of the illuminated spot formed by a single fiber image. For example, finding the point coordinates by determining the pixel corresponding to the location of the illuminated spot gravity center.

Correspondence between the input facet 428 of bundle 416 and individual fibers forming curved line 424 is easy to establish since only one fiber at a time picks-up the illumination reflected by mirror 504 or transmitted by slit 520 or aperture 524. The imaging system 440 that images the spot on the two-dimensional array may be a variable magnification system providing an illuminated spot of the desired size, further increasing the accuracy of spot coordinates on the switch determination. Practically, the scanning mirror, or slit, or diaphragm, are illumination modulation devices (or objects) that modulate the illumination along the sampled line. Determination of the coordinates of these devices along the illuminated line and corresponding to these location coordinates on the switch enable generation of a look-up-table (LUT). Generally, the LUT may be prepared at the optical sampling unit production stage, since once unit 112 is assembled, the relation between the sampled points 404 coordinates on the illuminated line 516 and the corresponding output plane 420 of fiber optics bundle remains constant. The calibration method described allows low cost non-coherent optical fiber bundles to be used. Typically, the LUTs would be stored in memory 142 (FIG. 1).

The system disclosed enables quality control of a thin film with the sampled points arranged substantially in a line or staggered line segments across one dimension of the substrate. A mechanism providing a relative movement between the thin film located in the object plane and the object plane 106 approximately perpendicularly to the direction of the illuminated line 516 (300, 408) on which sampled points 508 are located enables scanning and sampling of the other dimension of the thin film.

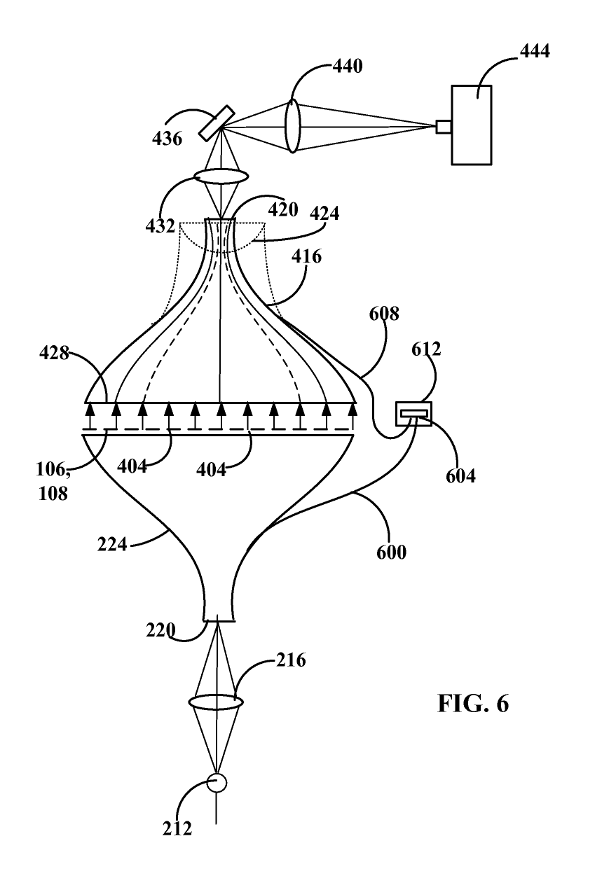

It is known that thermal drift of the light sources adversely affects the spectral stability of the illumination emitted by these sources and makes it insufficient for accurate determination of thin film optical parameters. The instability of the light sources may be compensated by a comparison of the spectrum to a known and stable source of spectrum and normalization of the measurement results. FIG. 6 is a schematic illustration of an exemplary embodiment of the spectral calibration facility of the sampling unit. One or more individual fibers 600 may be selected from fiber bundle 224 (FIG. 2) and their illumination could be used to illuminate an optically stable material 604, for example, a silicon substrate, which has stable and known optical properties. In a similar way, one or more fibers 608 may be separated from the receiving bundle 416 and configured to collect or receive reflected, transmitted or scattered illumination from calibration target 604. Location of fibers 608 on optical switch 436 (FIG. 4) could be determined in the process of coordinate calibration and the read-out of this spot would be used for calibration measurements only. The spectrometer signal received from each of the sampled points may now be calibrated with respect to the received spectrum of the silicon substrate 604 which will serve as a calibration target for measurement calibration.

Optical properties of silicon are stable so the changes that may occur in the quality control process are changes most probably relating to the changes in the spectrum of illumination source 204. In order to reduce the possible measurement errors that may be caused by the built into spectrometer 444 detector, the detector stability may be further improved by stabilizing detector temperature and excluding any environmental changes effect. This is usually done by coupling a detector with a thermoelectric cooler and packing the detector into a hermetically closed housing. Practically, the present system allows calibration of measurements of every reading of the detector and introducing/using the calibration results for actual spectrum measurement correction.

The simplest way to correct the results of spectrum measurement is to correct all sampled point measurement results on an equal value. Generally, calibration based on silicon calibration target or other optically stable target allows both a relative and absolute calibration of the spectrum measurement. For example, the silicon calibration target optical properties are well known and methods of calculating its absolute reflection coefficient are also known. For example, see U.S. Pat. RE 34,873. Each system may be produced with a calibration target and even the differences or change between the systems will be minimized. Other than silicon materials, such as glass, multilayer coatings similar to the controlled coating, and materials similar to the coating controlled, may be used for the calibration purpose.

Control unit 116 (FIG. 1) governs operation of system 100 units and synchronizes their operation. Control unit 116 performs processing of the spectral data acquired from sampled points 404. Processing of the determined spectral signal data and its transformation into thin film parameters is a computational process requiring significant computational resources and time. The present system replaces the time consuming computational process by a very fast process of comparison of the actual measured spectral signal to a similar spectral signal stored in a library of theoretical spectra calculated for different sets of thicknesses and optical constants of the measured thin films covering the entire variety of these parameters at the setup stage. The control unit processing consists of selecting a theoretical spectra data as close as possible to match the measured thin film spectrum data. Selection of a theoretical spectra data matching the measured thin film spectrum data is an exceptionally fast process enabling conducting thin film quality control at the speed of the photovoltaic panel on the production line advance

FIG. 7 is a schematic illustration of matching the actually measured spectra data of radiation reflected (or transmitted or scattered) from a thin film to a theoretical thin film spectrum. Numeral 700 refers to the actually measured spectrum reflected by the thin film 108 and numerals 704, 708 and 712 relate to the theoretical spectra calculated for different sets of thicknesses of the same thin film. Based on some merit function criteria of measuring the spectral differences of spectrum 712 could be selected as the one most closely matching spectrum 700. Theoretical spectrum 712 was calculated for a predetermined set of expected thin film parameters. As such, the thin film parameters included in the calculation of the theoretical spectrum are at least some of the group of film thickness (d), film refractive index (n), film extinction coefficient (k), film roughness, energy gap, conductivity, crystallinity and others which are the closest to the parameters of the measured spectrum. These parameters become the parameters characterizing the measured thin film.

FIG. 7 indicates that the spectrum has peaks and valleys. Generally, the film thickness determination could be supported by measurements at the peaks only. However, since other optical parameters such as refractive index (n) and extinction coefficient (k) should be determined, it is necessary to perform the measurements through the whole spectrum or at least at such sections of the spectrum where the sensitivity to selected variables is the highest one. Such sensitivity analyses may be carried out at the setup stage.

Control unit 116 (FIG. 1) includes a memory 142 containing, in addition to the look-up-tables, determining coordinates of the sampled points, a library of theoretical spectra calculated for different sets of thicknesses and optical parameters of measured films covering the entire variety of these parameters as well as a module receiving a panel coordinates from the panel translation facility during panel movement and synchronizes sampling time such that the sampling spot will be positioned in a pre-determined location, e.g. within an individual photovoltaic cell or alternatively within the scribe line, contact frame or specially introduced measurement targets. The principles of sampling points locations selection will be explained further in more details.

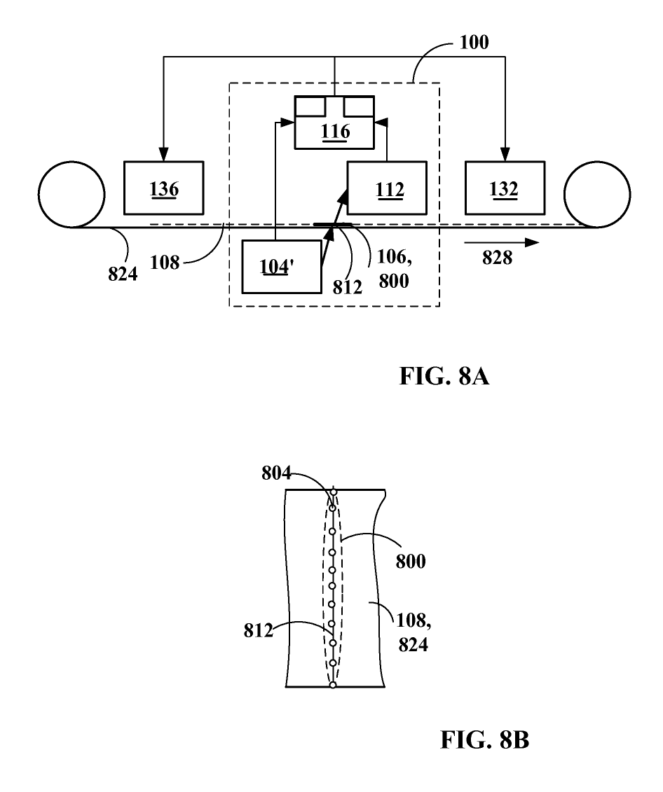

The system described is used for quality control of a thin film deposited on any substrate and, in particular, on a large area substrate. FIG. 8A is a schematic illustration of an exemplary embodiment of thin film quality control process. Illumination unit 104′, 104″, or 238 of system 100 illuminates object plane 106 coinciding with segment 800 of the surface of thin film. A suitable sampling unit samples the illumination transmitted or scattered by each of a number of discrete points 804 located on a straight-line 812 perpendicular to the plane of the drawing in illuminated section 800 of thin film 108. Discrete points 804 typically would be selected to be located about the center of an individual photovoltaic cell, although other configurations employing different number of fibers per photovoltaic cell or panel are possible. Optical switch 436 (FIG. 4A, 4D and FIG. 6) optically switches between sampled points 804 to enable sequential sampling of each of the points 804 by a single detector of spectrometer 444 (FIG. 4) or 460 (FIG. 6). Alternatively, as shown in FIG. 3 the sampled points may reside in different illuminated segments of the object plane and be placed on the same line by appropriate software or hardware signal processing. Spectrometer 444 or 460 determines the spectral signal of the illumination transmitted or scattered at points 804 of thin layer 108. Control unit 116 calibrates the measured signals by a signal measured on the calibration target and processes the spectrum e.g. by comparing it to theoretical spectra stored in the library, and following the comparison provides at least one thin film parameter based on the matching spectral signal characterizing a particular sampled point 804. Substrate 824 is a flexible web substrate translated in the direction indicated by arrow 828.

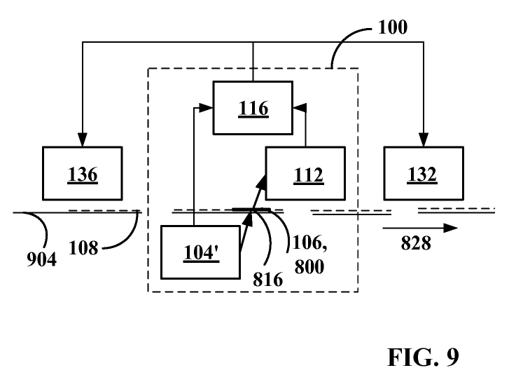

FIG. 9 is a schematic illustration of another exemplary embodiment of thin film quality control process. Substrate 904 is a cut-sheet substrate and may be a flexible or rigid substrate. FIGS. 8 and 9 relate to an in-line thin film quality control system. For off-line operation, system 100 would have its own thin film translation facilities.

In order to enable continuous thin film quality control, the controlled thin film is moved in a second direction 828 approximately perpendicular to the direction of line 812 on which sampled points 804 reside (FIG. 8B). This enables control of almost any desired number of points and at any location on substrate 824. A linear or rotary encoder may be used to control the thin film movement in the direction of arrow 828. The encoder may be also used to synchronize the timing of the measurements in order to perform them at a predetermined location along perpendicular direction. As illustrated in FIG. 8 and FIG. 9, the length of illuminated section 800 is equal or larger to at least one dimension of the substrate 824, which is the width of the substrate 824 on which thin film 108 is deposited. The coordinates of the sampled points 804 are defined a priori as explained above and all of the sampled points are illuminated by an illumination having the same spectral signal. The spectral range of the illumination is selected such that the thin film under control is partially transparent to at least a part of the illumination. The spectral range selection considerations are equally applicable to the reflectance and transmission based measurements. Raman scattering measurements are performed with the laser wavelength in the spectral range, where the measured film is at least partially absorbing.

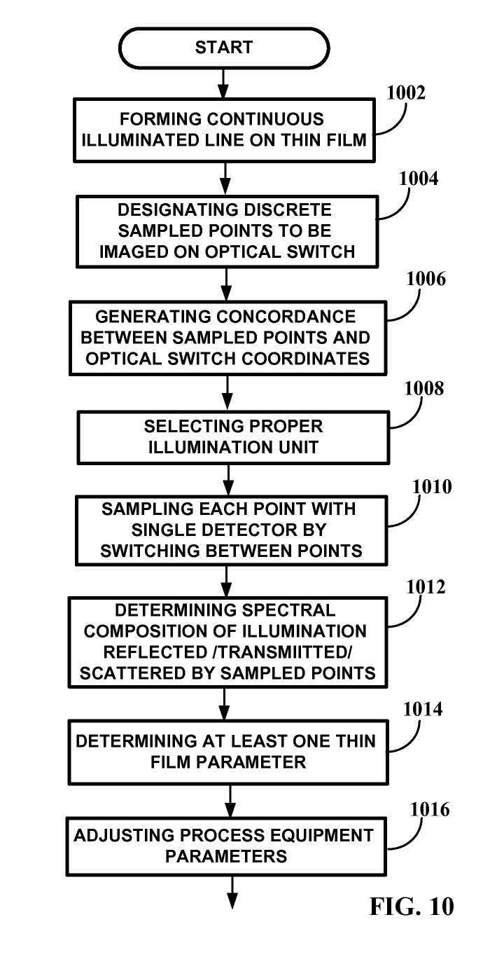

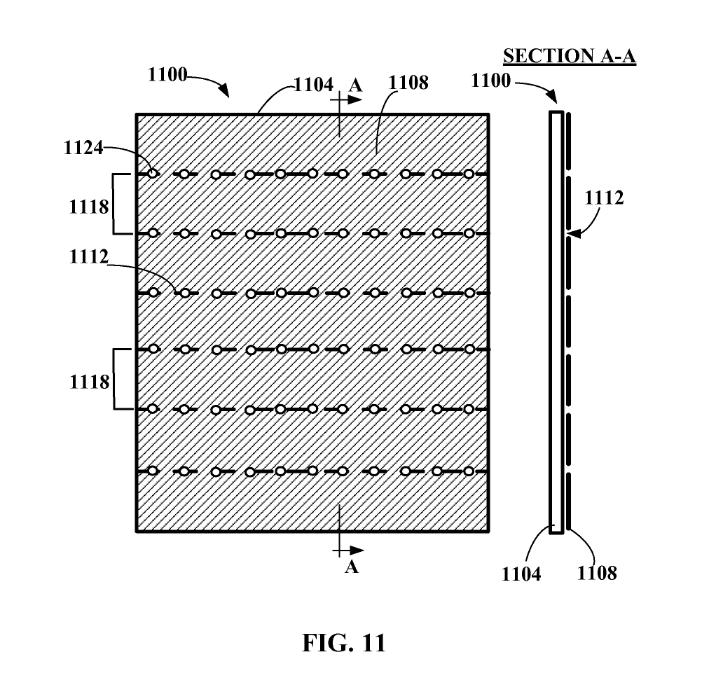

FIG. 10 is a flow diagram illustrating the steps involved in an exemplary system. The illustrated method is that of a photovoltaic thin film quality control process. The method initially begins by illuminating a section of a photovoltaic thin film by an appropriate illumination source and forming on the thin film an illuminated line (Block 1002). Following this, the method continues by designating a plurality of discrete sampled points located on said illuminated line, the points to be imaged onto an optical switch (Block 1004). Next, a concordance is generated between the coordinates of the sampled points on the thin film and their coordinates on the optical switch (1006). Next a proper illumination or light source for conducting spectral reflection/transmission or Raman scattering measurement is selected (1008), then each of the points are sequentially sampled by a single suitable detector by optically switching between the points (Block 1010). Finally, the spectral signal of the illumination reflected or transmitted or scattered by the sampled points is determined (Block 1012). Based on the spectral signal thin film parameters are determined (1014). If a deviation of at least one thin film parameter is found to exceed a predetermined value, manufacturing equipment process control parameters are adjusted to reduce the deviation of the measured thin film parameters from the desired or target parameters (1016). As a result the method operates to derive from the spectral signal at least one of a group of the photovoltaic thin film parameters consisting of the thin film thickness, thin film refractive index (n), thin film extinction coefficient (k), thin film surface roughness, thin film crystallinity, conductivity, energy gap, crystal phase, material composition and others. (Block 1014).

The method includes determination of the spectral signal data of the illumination or light reflected or transmitted or inelastically (Raman) scattered by sampled points. This may be done e.g. by comparison of the actual measured spectrum data to a theoretical spectrum stored in the memory, selection of the most appropriate theoretical spectrum, and conversion of the selected spectrum data loaded in a LUT into at least one of the thin film parameters associated with each sampled point. It is worthwhile to mention that if there would be no defects of the thin film controlled, the reflected (or transmitted or scattered) illumination would remain unchanged across the length of the illuminated line. The change in the thin film optical parameters varies the reflected/transmitted/scattered illumination spectrum and accordingly proper interpretation of this variation enables determination of thin film parameters such as the film thickness (d), the film refractive index (n), the film extinction coefficient (k), surface roughness, the film conductivity, energy gap (Eg), crystallinity percentage crystal phase and material composition. The determination of these parameters is performed, based on the closest matching theoretical and measured spectra. Some specific material parameters, e.g. energy gap parameter, can be extracted from the measurements of the thin film characteristics, for example by determining dielectric function models used for fitting the wavelength dispersion of the refractive index (n) and the extinction coefficient (k). Based on the thin film process control parameters as measures of the variation of thin film quality, manufacturing equipment process control parameters can be adjusted in order to control thin film quality including at least one of a group consisting of the deposition pressure, deposition time, deposition rate, deposition temperature, and deposition source material composition.

Should the deviation of the controlled parameters indicate on a defect in the controlled film presence, the defect location and type is communicated to forward 136 and backward 132 (FIG. 1) located, with respect to the quality control system 100 production systems or stations. The information communicated may include process correction instructions and, if possible, defect repair instructions.

A setup process precedes system 100 operation. The setup process includes at least the operations of generation of a concordance look-up-table between the coordinates of the sampled points 804 in the object plane 106 and their coordinates in the optical switch 436 (FIG. 4) and storage of the tables in memory 142. The setup process further includes generation and storage in memory 142 (FIG. 1) of a library containing a plurality of theoretical spectra of the thin film characterized by different sets of variable parameters. The setup process may also include loading of a library of the above theoretical spectra to the memory 142 of the control unit 116. The library may be prepared off-line and loaded through a communication link or by transferable media.

Another embodiment includes a method of determining parameters of a photovoltaic thin film deposited on a substrate in a patterned photovoltaic panel where the panel includes multiple individual photovoltaic cells. This embodiment starts by providing at least one photovoltaic cell panel and one or more optical sampling systems. The method continues by enabling relative movement between the optical sampling system and the panel, and controlling the movement. Next the locations of individual photovoltaic cells on the panel are mapped and, each sampled point location is synchronized such that the sampled point reading takes place, when the sampled point is located at a pre-determined place along the panel movement path. Below are presented principles of sampled points locations selection and additional exemplary embodiments related to the implementation of the above measurement method and apparatus for specific locations on a PV panel. Sampled points may be located in any place on the PV panel. Selection of the sampled point at locations on the PV panel where only one (single) or reduced number of thin film layer exists may simplify the spectra measurement process and measurement data processing, since the measurements are not influenced by interference with other layers. For example, sampled points located within scribe lines, contact layer frame or dedicated sampling targets that may be produced by laser ablation, may represent such locations.

FIG. 11 is a schematic illustration of a photovoltaic panel at one of the stages of an exemplary photovoltaic panel production process. At this stage of the process photovoltaic panel 1100 includes a substrate 1104 with a first thin or contact film 1108 deposited on it. Scribe lines 1112, shown for clarity as broken lines, may also be made at this production stage. Scribe lines 1112 are formed by removing a narrow strip, of the material for example, contact layer material leaving clean substrate 1104. The orientation of scribe lines 1112 depends on particular panel 1100 design and other orientation/direction of scribe lines is possible. Scribe lines 1112 cut the thin films deposited on substrate 1104 of panel 1100 into multiple strips 1118, called photovoltaic cells or simply cells, which are connected in series, thereby providing a combined high voltage output. This method of connecting cells in series is often called monolithic integration.

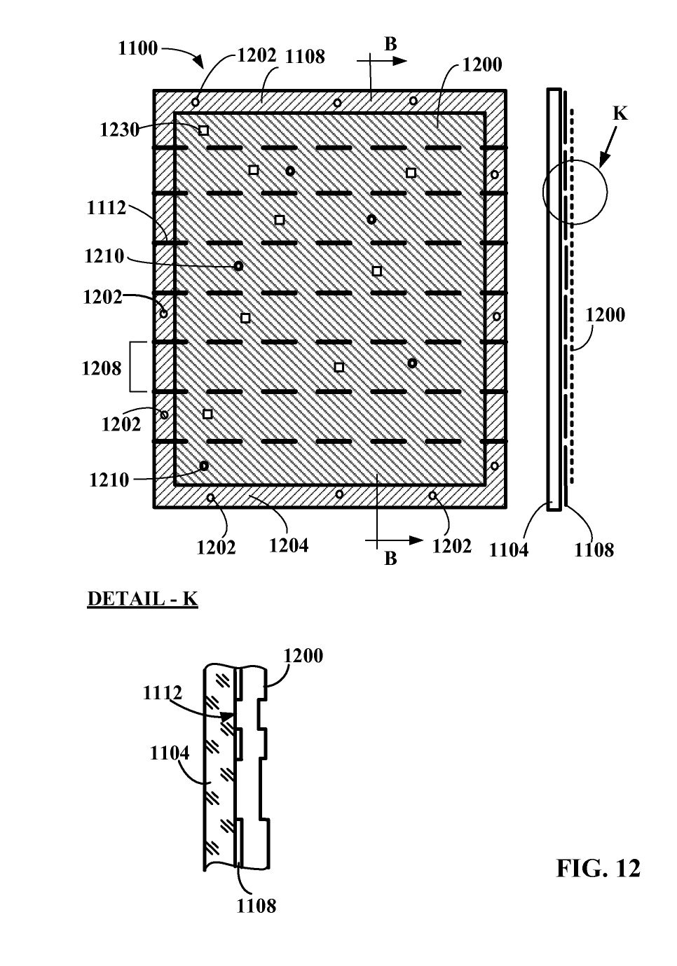

FIG. 12 is a schematic illustration of a typical photovoltaic panel substrate after another stage of an exemplary panel production process. An absorbing or photovoltaic layer 1200 is deposited over the first contact layer 1108. In photovoltaic panels the absorbing thin film 1200, which is typically a semiconductor material like silicon (Si), cadmium telluride (CdTe), copper indium gallium di-selenide (CIGS) or the like. As known in the art, the absorber layer can consist of multiple sub-layers. Layer 1200 is not deposited over the entirety of the substrate 1104 and first contact layer 1108. Typically, the absorbing thin film layer 1200 is deposited through a mask leaving a few millimeters wide frame 1204 along the perimeter of the panel and proximate to substrate 1104 edges. Frame 1204 would possibly contain only the first contact layer 1108 and would be free of the absorbing layer 1200. Sampling points 1202 where the optical properties of the first contact layer 1108 are measured would typically be located within frame 1204.

A series of properly located scribe lines (schematically shown as lines 1112.) dissect the absorbing layer 1200 to additionally separate the photovoltaic cells. A second contact layer being a conductive film of transparent TCO or opaque metal, (not shown) that covers the absorbing film 1200 is deposited at the next stage forming a photovoltaic panel where the absorbing film is located between two contact films. Another series of proper located scribe lines dissecting the second contact layer to form photovoltaic cells will be introduced at a later stage. A number of dedicated sampling targets or metrology measurement targets 1210 representing small panel areas where specific contact or absorption material layer has been removed may be formed in panel 1100. The material is removed during the scribing process step, usually performed by laser, which may take place after the absorber layer 1200 deposition or after the contact layer deposition. These targets 1210 are subsequently coated with additional layer of material, and spectral measurements including transmission can be performed. The area of the target 1210 as compared to the area of the cell 1208 is small and does not significantly affect the output of the cell. Therefore, if the area of the target 1210 relative to the area of a photovoltaic cell 1208 is small, at a level less than the statistical variation of the photocurrent of various cells in the solar panel, and the degradation of the solar panel energy efficiency will be negligible. Targets 1210 may be produced to remove the first contact layer and the absorbing layer forming a sampling target for the second contact layer to be deposited at a later stage. Targets 1230 may be located in any place of the photovoltaic cells 1208 and they schematically mark measurement locations where all three thin film layers are present.

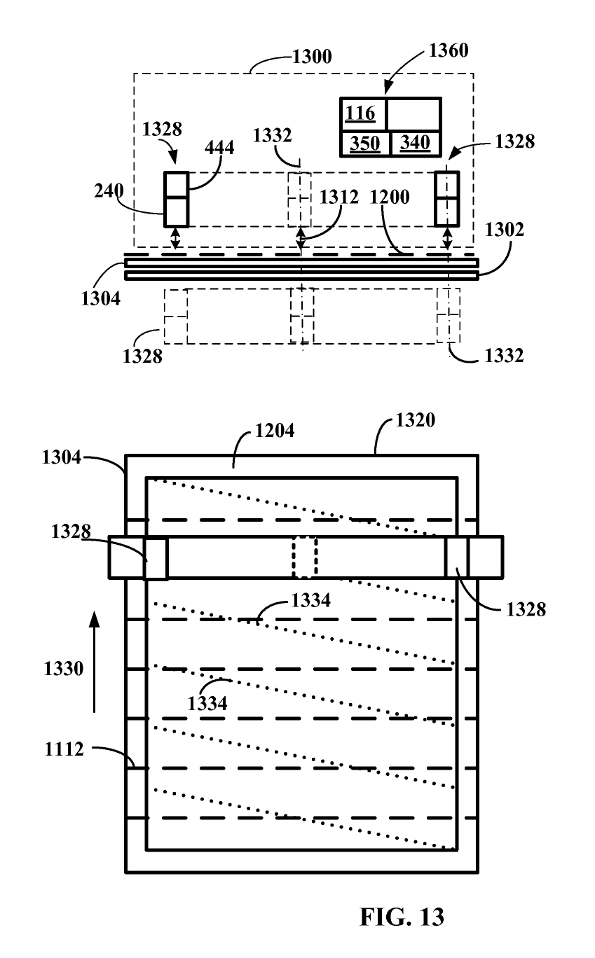

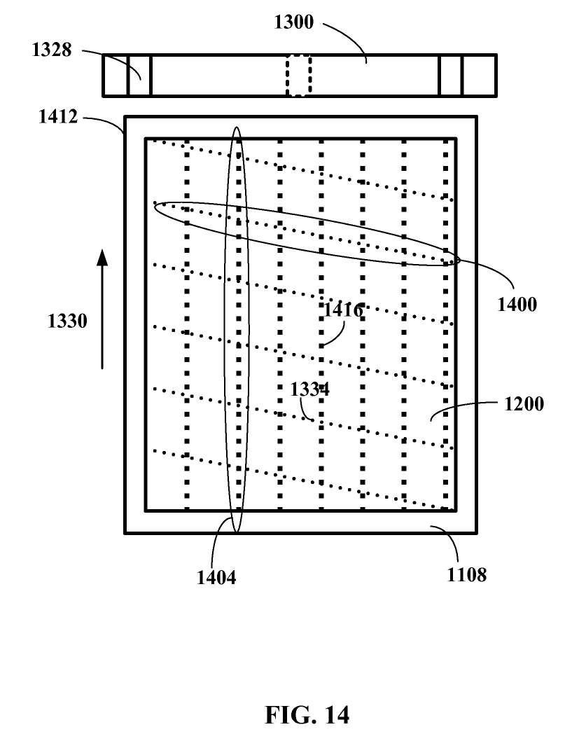

FIG. 13 is a schematic illustration of an exemplary photovoltaic panel quality control apparatus. Apparatus 1300, which may be produced for example, by modification of apparatus 100, includes a support 1302 for photovoltaic panel 1304, one or more polychromatic or monochromatic illumination sub-units 240 may be operative to provide a polychromatic or monochromatic optical illumination 1312, one or more illumination detecting units 444 may operate to detect the spectrum of reflected or transmitted from/by a single layer or a stack of layers, polychromatic optical radiation 1312, and control unit 116 operative to receive the detected intensity and wavelength (spectrum) of the reflected optical radiation and calculate the parameters of the measured layer or stack. The apparatus enables measurements of the reflected or transmitted radiation intensity and wavelength providing sufficient data for accurate determination or calculation of the thin film parameters and enabling corresponding production process control. Illumination sub-units 240 and detector units 444 may form a measurement unit 1328 and may have a common packaging. Substrate support 1302 supporting the photovoltaic panel 1304 could be configured to enable measurement unit 1328 operation from different spatial locations for example, from a location/side facing the substrate or the first location or a location facing the absorbing layer/side or second location or in a combination of both locations. When measurement units 1328 are located on both sides of the panel 1304 their optical axes 1332 are optionally coaxial, thereby enabling measurement of reflected illumination from both sides and also transmitted radiation in at least one direction and at the same sampling point.

Apparatus 1300 includes multiple measurement units 1328. Units 1328 may be identical units although some of them may perform additional to measurement functions. For example, some of the units may be pre-aligned so as to be located at specific locations of the moving panel 1304, which may be locations of scribe lines and other measurement targets or production features present on the photovoltaic panel, where a reduced number of thin films exists. Some of the units 1328 may be configured to detect the edge 1320 of a photovoltaic panel 1304 translated by support 1302. Control unit 116 controls operation of the apparatus 1300, provides thin films optical parameters determined by processing the illumination reflected or transmitted by a particular thin film layer, and manages communication with located upstream or downstream production stations.

A sampling mechanism enables relative displacement, shown by arrow 1330 between the controlled panel and the measurement units, such that almost all points on the panel may be accessed by one or more measurement units 1328. Measurement units 1328 are typically configured to sample points located on a straight line and may sample simultaneously different sampling points 1334 on controlled panel 1304. In an additional embodiment only one detecting unit may be operative to read sequentially the sampled points 1334. In this case, as shown in FIG. 13 the line with the sampled points 1334 will have an angle different from 90 degrees to the scanning direction shown by arrow 1330.

Each of the measurement units 1328 may operate at a different sampling frequency or resolution and as shown in FIG. 14 different segments 1400 and 1404 of a photovoltaic panel 1412 may be sampled with different sampling frequency or resolution. Numerals 1334 and 1416 mark sampled points sampled with different sampling frequencies. For example, some of the measurement units may be set to operate with a sampling frequency or resolution substantially higher than the resolution (for example, points 1416) at which other measurement units operate. Measurement units operating at a higher resolution provide information additional to the measurement units operating at lower resolution information for thin film optical parameters determination. Sampling of the PV panel may be controlled in two different resolutions enabling more accurate layer parameters mapping and providing access to finer details on the expected profile of the thin layers as well as ability to detect local excursions of the profile.

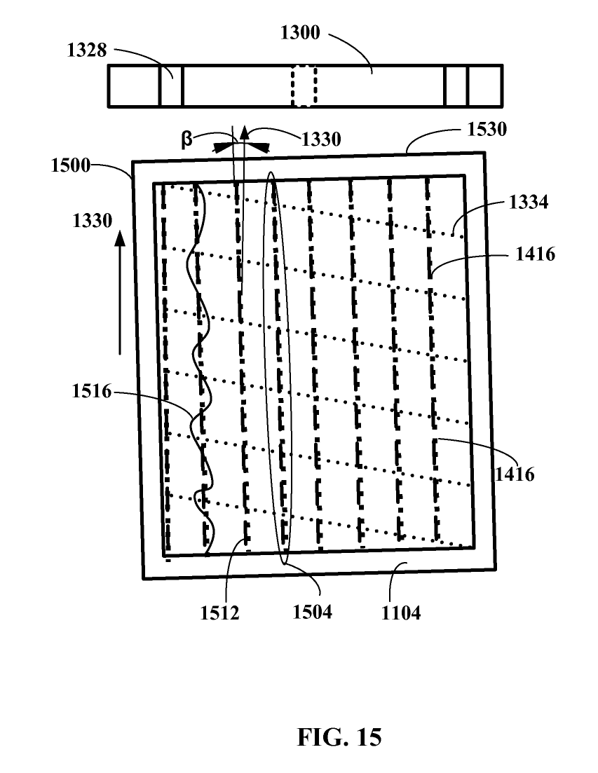

According to one embodiment of the present method the thin film parameters measurement is performed in sampling points where a reduced number of thin film layers and typically only one thin film layer exists and the measurement is not affected by noise or interference with other overlapping thin film layers. Sampling points 1202 (FIG. 12) where optical parameters of the first contact layer 1108 (FIG. 11) are measured would typically be located in a free of absorption layer 1200 contact layer frame 1204 (FIG. 12). Measurement of transmission or reflection spectrum characterizing the absorbing layer 1200 could be performed in sampling points 1124 (FIG. 11) and 1416 (FIG. 14) located within the scribe lines 1112 (FIG. 11) and 1512 (FIG. 15) where the contact layer 1108 has been removed. The orientation of the scribe lines depends on the particular panel design and, as shown in FIGS. 11 and 12, scribe lines 1112 may be oriented along the short panel side or as shown in FIG. 15 scribe lines 1512 may be oriented along the long side of a panel 1500 (FIG. 15).

Photovoltaic panels, the quality of which is being controlled, may be displaced or moved with respect to the measurement units 1328 by a conveyor or a table like support. (In some embodiments, the measurement unit may be displaced with respect to a static panel.) However, the panels placed on the support 1302 may not necessary be oriented such that the production elements, for example, scribe lines and the panel itself are not parallel or perpendicular to the panel movement direction. The scribe lines may be at an angle β (FIG. 15) with respect to the panel movement/displacement direction shown by arrow 1330. According to the present method some of the sampled points are located within the scribe lines, where at this stage of the production process there is only an absorption layer 1200 (FIG. 12) present. Panel spatial location, which is at an angle to the panel movement direction 330 further complicates determination of the scribe lines location. Apparatus 1300 (FIG. 13) includes a scribe line location and orientation determination mechanism (not shown). A section of this mechanism may be located in the measurement unit 1328 and a section 1350 of it may be incorporated into a controller 116 assembly 1360.

There are different line location detection methods such as following an edge of the line, staying in the middle of the line, keeping the detected line between two or more sensors, moving back and forth over the line (cross over). Generally, line following or tracking relies on the fact that the line tracking sensor senses the difference in the signal produced by the line and the surrounding the line area. The difference between the signal produced by the line and the background enables accurate line following or steering along the line. Any one of the methods may be employed for scribe line tracking/following.

The line detection and associated with it line following mechanism may include a scribe line identification device such as a two dimensional CCD or a quadrant detector (not shown) located within a measurement unit 1328 with proper processing electronics 350 located in controller assembly 1360. Upon receiving from the scribe line identification section of the mechanism location of the scribe line, the processing electronics 350 may generate an instruction to an optical scanning device such a galvanometer type scanning mirror, a linear motor, or similar to locate the illumination probe and if necessary the detection probe (or both together) of the measurement unit 1328 above the scribe line 1512. The correction signal may be generated on a continuous basis and as shown by line 1516 the scanning device would continuously follow the scribe line 1512 according to any one of the described above line location detection and tracking methods. The continuous following of the scribe line will cause, as shown by numeral 1504 to perform spectral measurements of sampling points 1416 located within the scribe line.

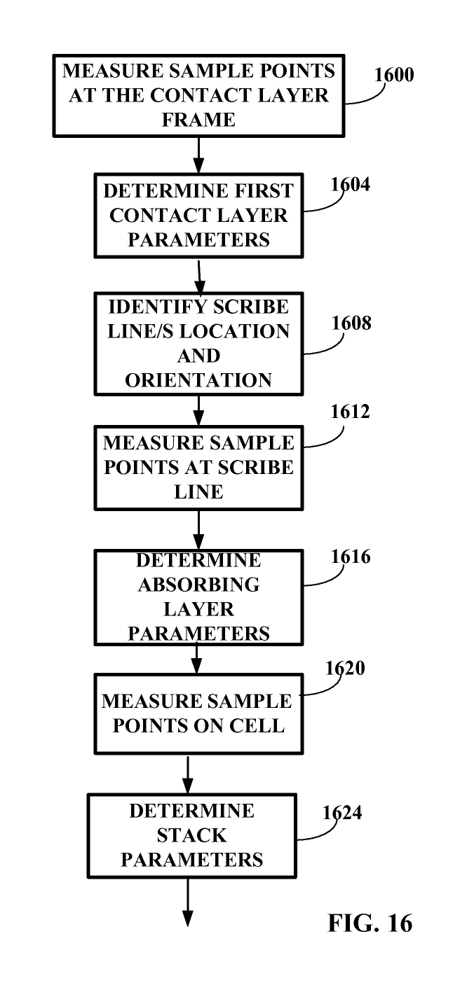

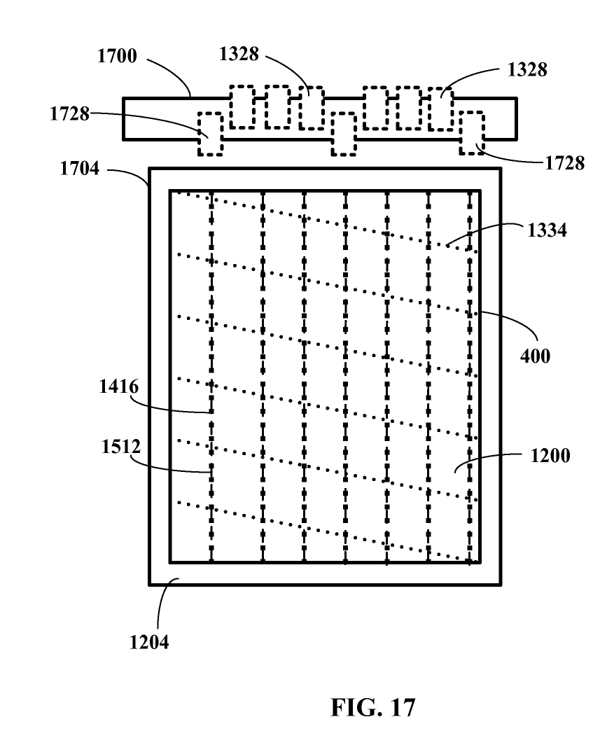

FIG. 16 is a flow chart illustrating the process of photovoltaic panel quality control process according to the present method. Upon panel arrival to the quality control station 1300 (FIG. 13) controller 116 activates two or more of the measurement units 1328 and operates them to detect photovoltaic panel 1500 (FIG. 15) orientation by detecting panel edge 1530 orientation. Alternatively, optional edge detection units may be used for edge detection. An optional position control module or modules can be operative to provide lateral and longitudinal positioning movement to measurement units 1328 or operate a line positioning and following mechanism. Measurement units 1328 measure the spectrum of the reflected or transmitted illumination at sampling points 1202 located at the panel 1100 edges 1104 or contact layer frame 1204 (Block 1600). (The measurement of the first contact layer properties may be performed in any location of contact layer frame 1204 and sampling points 1202 are indicated for the clarity of the explanation only.) Control unit 116 uses the reflected illumination intensity to determine optical parameters of the first contact layer 1108 (Block 1604). This information can be used to more easily calculate the parameters of the full layer stack measured at sampled points 1334 and 1416.

Parameters of the absorption layer are measured separately using sampling points located within scribe lines 1512 (FIG. 15). The measurements may be performed from both the substrate side and the absorption layer side. Since the orientation of each of the panels may be different, the measurement units 1328 (FIG. 13) are set to detect the panel/edge 1530 orientation. Additional edge detectors (not shown) known in the art can be used, where a number of such detectors are located along apparatus 1300. Measurement units 1328 may communicate the panel edge orientation to controller 116, which based on this data will calculate the lateral offset and angle of the scribe line 1512 (Block 1608), in relation to a nominal position and nominal angle of the panel. (In some embodiments the determination of spatial orientation of the controlled panel may be the first process step.) Controller 116 calculates correct location of scribe lines 1512 and sends a signal to the measurement units identifying the sampling points located on or within scribe lines. Measurements are performed in the scribe lines by measurement units 1328 (Block 1612). Based on the intensity of the reflected optical radiation controller 116 determines optical parameters of the absorbing layer 1200 (Block 1616). The measurement of the radiation reflected or transmitted by the absorbing layer may be performed from the substrate side also. Thin film layer measurements are performed by measurement units 1328 on cell areas containing the full layer stack typically at multiple sampled points 1334 and 1416 (block 1620). In some specific cases the measurements may be performed in dedicated measurement targets 1220 and 1230 (FIG. 12) where a reduced number of thin films exists or a full stack of thin films is present.

The measurement results are compared with an optical model of the layer stack while also utilizing the data obtained for the locations with reduced number of layers in the measured stack such as at contact layer frame locations 1204 (FIG. 12) and/or at scribe line locations 1112 or metrology target locations 1220. Based on the separate measurements, parameters obtained from such simplified (preferably single layer) stacks can be inserted into the full optical model of the cell for determination of at least one additional parameter of this cell (block 1624). The analysis of the measurements on the full stack (sampling points 1230 FIG. 12) based on the accomplished optical model can provide more accurate determination of parameters of the stack and may be communicated to the upstream or downstream located production station, where if necessary, process correction actions may be taken. It should be noted that although the method presented in FIG. 16 includes measurements of the stacks with reduced number of layers in the frame area and in the scribe lines, in many cases it is sufficient to measure only one of these two places: either in the frame area or in the scribe lines.

If the panel is rotated on a relatively large angle β, with respect to the direction of the panel movement or translation 1330 (FIG. 15) the scanning mirror or linear motor range may be not sufficient to cover for the scribe line offset. In one embodiment, measurement units 1328 are organized to have an overlapping field of view and tracking of the scribe line may be switched to the next appropriate measurement unit 1328. In another embodiment, measurement units 1328 have a freedom of movement along or across the apparatus 1300. One of the neighbor measurement heads 1328 or even the same measurement head 1328 may be shifted/moved to include the tracked scribe line in the field of view of the unit.

At least some of measurement units 1328 could be set to follow the scribe line orientation with the help of a mechanism which, as explained above, introduces a corrective (cross over) motion to the measurement unit illumination and measurement spots. Such mechanism may be for example, a scanning mirror a controller of which receives feedback from scribe line position location mechanism. Location of production features and in particular scribe lines follows certain design rules and their relative location with respect to each other is known from the panel design. For example for scribe lines 1112 (FIG. 11 and FIG. 13) controller 116 (FIG. 1) may calculate the required timing for measurement in the scribe lines and other measurement targets and thereafter the measurement units are appropriately activated/triggered to perform synchronized measurements of sampled spots located on or within scribe lines 1112 or measurement targets 1220 or 1230 (FIG. 12). For scribe lines parallel to the direction of motion as in FIG. 14, the corrective motion mechanism can be used to keep the measurement locations 1416 in the cell area between scribe lines or alternately keep the measurement locations 1416 on the scribe line. The latter method enables providing dense measurement data of the absorber layer characteristics along the length of the photovoltaic panel. Thus layer stack parameter determination (block 1620) performed for different rows of measurement points 1334 or 1416 have available absorber layer optical characteristics determined from a nearby location.

Measurement of second contact layer parameters may be performed by another system similar to system 1300 (FIG. 13) and located at a downstream station of the production line. The second contact layer optical parameters are typically determined by measurements from the absorption layer side where the second contact layer directly faces the measurement system 1328. The second contact layer optical parameters may now be relatively easy and accurately determined by measuring layer parameters in specially prepared dedicated locations or by measuring the stack parameters and sharing the first contact layer and the absorbing layer parameters obtained from upstream system 1300 in determination of the parameters of the second contact layer.

Measurements are repeated at multiple positions along the length and width of the panel and they enable generation of a map of the panel characteristics. Data from all measurement units received and processed by control unit 116 (FIG. 1 and FIG. 13) may be combined and an optical model of the thin film stack may be built. U.S. Provisional Patent Applications No. 61/160,294 (Presently Patent Cooperation Treaty Application PCT/IL2010/000174 filed on Mar. 3, 2010) and 61/160,374 (Presently Patent Cooperation Treaty Application PCT/IL2010/000175 filed on Mar. 3, 2010) to the assignee of the present application disclose methods of analyses of such stacks. Deviations of the measured layer/stack parameters may be communicated by communication unit 1340 to production stations located upstream or downstream and process corrective actions undertaken.

Different measurement schemes can be introduced based on this method. FIG. 7 is a schematic illustration of an additional exemplary photovoltaic panel quality control apparatus 1700, whereby for example, every fourth measurement head 1728 similar to measurement head 1328 follows a scribe line 1512 of panel 1704, while the three other measurement heads 1328 in between measure in the cell area. The ratio of density of measurements in the movement direction can be determined based on the known within-panel process variability of the different layers. For example, in some cases the contact layer optical parameters have a low level of variability compared to the absorber layer optical parameters variability. In this case the contact layer characteristics determined from the contact frame area 1204 have strong correlation to the conditions of the layer within the whole panel, for example the thickness and roughness vary less than 3%. On the other hand, the absorber layer thickness may vary in thickness by over 10%, thus requiring denser mapping of points to characterize and control the process. Performing high resolution scans on the scribe lines and lower resolution scans in the cells enables providing of mapping of optical characteristics information at resolution relevant to the process changes, thus enabling effective control of the process by communicating changes in the characteristics to upstream and downstream processing stations.

A number of embodiments have been described. Nevertheless, it will be understood that various modifications may be made without departing from the spirit and scope of the method. Accordingly, other embodiments are within the scope of the following claims:

What is claimed is:

1. A method for accurate determination of parameters of a stack of thin films of a photovoltaic panel, said method comprising:
providing a substrate with one or more thin films deposited on the substrate and forming a photovoltaic panel;
illuminating the panel by at least one of illuminations consisting of a broadband illumination and monochromatic illumination; and
detecting spectrum of collected illumination;
utilizing existing on the panel elements having a stack with reduced number of thin film layers and enabling measurement of optical parameters of at least one thin film layer; and
determining at least one additional parameter of the cell stack using the parameters of said stack with reduced number of thin films.

2. The method according to claim 1 wherein the existing on the panel elements are at least one of a group of elements consisting of a scribe line, contact layer frame, and dedicated measurement targets.

3. The method according to claim 2 wherein the optical parameters of the contact layer are determined by a measurement performed in a contact layer frame free of an absorbing layer.

4. The method according to claim 2 wherein measurement performed in the scribe lines determines the optical parameters of an absorbing layer.

5. The method according to claim 4 further comprising following the scribe line location by introducing the scribe line position feedback into one or more measurement units.

6. The method according to claim 1 further comprising sampling the panel to be measured with at least one spatial resolution.

7. The method according to claim 6 wherein sampling the panel is made with at least two spatial resolutions, and wherein at least one of the resolutions is substantially higher than the other resolution.

8. The method according to claim 7 wherein scanning the panel in a higher resolution provides information additional to the lower resolution for optical parameters determination.

9. The method according to claim 7 wherein scanning in two resolutions enables accurate thin film layer parameters mapping.

10. The method according to claim 1 also comprising determining the optical parameters of each of the thin film layers by relative movement of one of the substrate or measurement system.

11. The method according to claim 10 wherein the measurement system is located in at least one of a group of spatial locations consisting of a location facing absorbing layer, or a location facing the substrate or in a combination of both locations.

12. The method according to claim 11 wherein the measurement system located opposite the absorbing layer and the measurement system located opposite the substrate are coaxial systems.

13. The method according to claim 11 wherein the measurement system also comprises an illumination system and an illumination detection system.

14. The method according to claim 13 wherein the illumination detection system is operative to detect illumination transmitted or reflected by a thin film.

15. The method according to claim 13, wherein the illumination detection system is a spectrometer operative to determine the spectral composition of illumination reflected or transmitted by the corresponding sides of the thin films stack.

16. The method according to claim 2 further comprising determining optical parameters of at least one thin film from the substrate side and at least of one thin film from absorption layer side.

17. The method according to claim 2, wherein the optical parameters of the thin film are at least one of a group consisting of the thin film thickness (d), thin film refractive index (n), thin film extinction coefficient (k), film surface roughness, energy gap, crystallinity, phase composition, conductivity, and stoichiometry.

18. The method according to claim 2 further comprising utilizing optical parameters of each of the thin film layers to build an optical model characterizing interaction of optical radiation with the measured thin film by a set of optical and geometrical parameters of each of the thin films.

19. The method according to claim 2 further comprising combining the optical models of individual thin films to build an optical model characterizing interaction of optical radiation with a stack formed by the measured thin films by a set of optical and geometrical parameters of each of the stack.

20. A method of a photovoltaic thin film quality control, said method comprising:
illuminating one or more discrete sampled points of a stack of thin layers forming a photovoltaic panel;
determining the spectral composition of the illumination reflected by the sampled points;
deriving from the spectral composition at least one of a group of the photovoltaic thin film parameters consisting of the thin film thickness (d), thin film refractive index (n), thin film extinction coefficient (k), thin film surface roughness, crystallinity, energy gap, phase composition, conductivity, stoichiometry, and
wherein locations of the sampled points are selected such that each sampled point contains a partial layer stack.

21. The method according to claim 20 where the partial layer stacks consist of at least a single thin film layer.

22. The method according to claim 20 further comprising:
comparing the derived photovoltaic thin film parameters to the parameters of a theoretical defect free thin film;
determining deviation of the derived thin film parameters from the theoretical thin film parameters; and
wherein the deviations of the derived thin film parameters from the theoretical thin film parameters indicate on the quality of the photovoltaic thin film.

23. The method according to claim 20 wherein locations of the sampled points are selected from one of a group of locations consisting of panel features such as scribe lines, contact layer frame devoid of absorption layer, and dedicated measurement targets.

24. The method according to claim 23 further comprising following the scribe line location by introducing position feedback into measurement system.

25. A method of a photovoltaic panel quality control, said method comprising:
determining optical parameters of a first contact layer deposited directly on a substrate;
utilizing a scribe line to determine parameters of optical radiation absorbing layer;
combining the parameters of the measured layers to produce an optical model of a stack deposited on the panel.

26. The method according to claim 25 wherein the optical parameters of the first contact layer are determined by a measurement performed in a contact layer frame free of absorbing layer.

27. The method according to claim 25 wherein utilizing scribe line measurements further comprising tracking location of said scribe line.

28. The method according to claim 25, wherein the contact layer and the absorbing layer parameters are at least one of a group consisting of the layers thin film thickness (d), thin film refractive index (n), thin film extinction coefficient (k), film surface roughness, energy gap, crystallinity, phase composition, conductivity and stoichiometry.

29. An apparatus for determination of thin films stack parameters, said apparatus comprising:
one or more illumination sources consisting of polychromatic illumination sources or monochromatic illumination sources operative to illuminate corresponding sampling points;
one or more illumination detectors operative to detect a spectrum of the illumination collected from the corresponding sampling points of the thin films stack;
a controller operative to synchronize operation of the illumination sources and the detectors, receive and process the detected illumination and derive optical parameters of the thin films forming the measured stack.

30. The apparatus according to claim 29 further comprising selecting the sampling points locations such that measured sampling point stack contains a reduced number of thin films.

31. The apparatus according to claim 29 further comprising measurement units located on opposite sides of a thin films stack.

32. The apparatus according to claim 29 wherein the optical parameters of the thin film are at least one of a group consisting of the thin film thickness (d), thin film refractive index (n), thin film extinction coefficient (k), film surface roughness, energy gap, crystallinity, phase composition, conductivity and stoichiometry.

33. An apparatus for accurate measurement of a stack of thin films parameters, said apparatus comprising:
a support operative to support and move a photovoltaic panel comprising a stack of thin films, said support enabling to illuminate the stack from a first side and a second side;
one or more measurement units including a polychromatic or monochromatic illumination device operative to illuminate the stack of thin films; and
at least one detector operative to detect collected illumination from the stack of the thin films;
a controller operative to receive the value and wavelength of the collected illumination, determine at least one of thin film optical characteristics in a sampled point where the stack has a reduced number of thin film layers, combine said characteristics into an optical model of the full stack, and determine optical parameters of the full stack.

34. The apparatus according to claim 33 wherein the controller is further operative to synchronize the movement of the support and the measurement units, a scribe line identification mechanism, and scribe line following mechanism.

35. A method of scribe line location detection, said method comprising:
identifying at least one scribe location;
obtaining from a control system the distance between the scribe lines;
determining the time of the next crossing of a measurement unit field of view; and
performing the measurements in the scribe line.

36. A method of a photovoltaic thin film quality control, said method comprising:
illuminating one or more discrete sampled points in a stack of thin layers forming a photovoltaic panel;
selecting the sampled point location where the stack consist of a single thin layer;
determining the spectral composition of the illumination reflected by the sampled points;
deriving from the spectral composition at least one of a group of the photovoltaic thin film parameters consisting of the thin film thickness (d), thin film refractive index (n), thin film extinction coefficient (k), thin film surface roughness, energy gap, crystallinity, phase composition, conductivity and stoichiometry.

37. The method according to claim 36 wherein locations of the sampled points are selected from one of a group of locations consisting of panel production features such as contact layer frame devoid of absorption layer, scribe lines, and dedicated measurement targets.

38. A method of a photovoltaic thin film quality control, said method comprising:
illuminating one or more discrete sampled points located in scribe lines of a stack of thin layers forming a photovoltaic panel;
following the scribe line location by introducing position feedback into measurement system;
determining the spectral composition of the illumination reflected by the sampled points; and
deriving from the spectral composition at least one of a group of the photovoltaic thin film parameters consisting of the thin film thickness (d), thin film refractive index (n), thin film extinction coefficient (k), thin film surface roughness, energy gap, crystallinity, phase composition, conductivity and stoichiometry.

39. The method according to claim 38 wherein the scribe line locations are oriented at an angle to direction of panel displacement.
